(19) United States
(12) Patent Application Publication
(10) Pub. No.: US 2009/0146587 A1
(43) Pub. Date: Jun. 11, 2009

(54) Completely Sealed High Efficiency Microwave Sulfur Lamp

(76) Inventor: Zhenda Li, Shanghai (CN)

Correspondence Address: Wing P. Leung, 1276 E. Colorado Blvd., Suite 202, Pasadena, CA, 91106, US

(21) Appl. No.: 11/953,140

(22) Filed: Dec. 10, 2007

(51) Int. Cl. H05H 7/00

(52) U.S. Cl. 315/501

(57) ABSTRACT

A completely sealed microwave sulfur lamp is made possible by removing the heat generated from the magnetron and high voltage direct-current power supply via heat conducting oil, rubber and resin. An oil pump is used to circulate the heated oil to the metallic housing of the lamp for natural cooling. No forced air cooling is needed. High efficiency power supply is used to reduce the heat generated. The low ripple direct-current high voltage generated also contributes to lower heat generation at the magnetron.

### REFERENCES

U.S. Patent Documents

| | | |
|---|---|---|
| 5,334,913 | August 1994 | Ury, et al. |
| 5,404,076 | April 1995 | Dolan, Ury and Wood |
| 5,438,242 | August 1995 | James L. Simpson |
| 5,493,184 | February 1996 | Wood, et al. |
| 5,825,132 | October 1998 | Gabor, et al. |

### FIELD OF THE INVENTION

This invention is related to high intensity, highly efficient and sealed microwave sulfur lamp.

### BACKGROUND OF THE INVENTION

Microwave sulfur lamp is a high efficiency and high intensity illumination device capable of producing a continuous spectrum similar to that of the solar spectrum in the visible region. It is most suitable for use in highways, bridges, tunnels, airports, piers, terminals, factories, stadiums, hotels, scenic areas and other outdoor locations. The sulfur lamp bulb consists of inert gas such as Argon and a small amount of sulfur. When excited by microwave at 2450 MHz, the inert gas (Argon in most cases) is ionized which in term heats up the sulfur into a gaseous state. The highly excited sulfur vapor forms diatomic molecules. When the excited diatomic sulfur molecules return to their lower energy or ground states, light is emitted. Since sulfur molecular energy levels are nearly continuous at high temperature, a continuous spectrum similar to sunlight is obtained.

The excitation and running of a conventional microwave sulfur lamp relies on a 2450 MHz magnetron driven by a high voltage direct-current (DC), which in term generated by a LC high voltage power transformer. The efficiency of LC power transformer is quite low, in the range of 60-70%. As a result, a significant amount of heat is generated. The DC high voltage generated by the LC power transformer has high ripples, thus reducing the efficiency of the magnetron to about 60-70%. The heat generated by the inefficient magnetron may increase the anode temperature to more than 350 degrees Celsius which would greatly reduce the life of the magnetron. In order to protect the magnetron and the lamp from overheating, strong forced air is used to cool the lamp. The stringent cooling requirement makes the sulfur lamp bulky and noisy. These shortcomings limit the popularity of sulfur lamps in commercial use.

### BRIEF SUMMARY OF THE INVENTION

Existing sulfur lamps generate a large amount of heat when operating. It requires strong forced air cooling. As a result, the lamps are bulky, noisy and are not sealed. This invention improves the efficiency of a sulfur lamp; reduces the heat generated by the wasted energy; and employs new ways of cooling without the use of forced air. Consequently, the sulfur lamp may be packed in a completely sealed package.

### DESCRIPTION

This invention describes a way of constructing a completely sealed sulfur lamp which dissipates the heat it generates without the use of forced air cooling.

The invention involves a completely sealed sulfur lamp which consists of a DC high voltage power supply with associated coupling circuitry to the magnetron. With the excitation of the DC high voltage generated by the high voltage power supply, the said magnetron generates the microwave required to excite the quartz bulk which contains an inert gas and a small amount of sulfur. The specific characteristic of the said sealed sulfur lamp consists of the said high voltage DC power supply and the magnetron with the case. The said case has heat conducting media to improve heat dissipation.

Preferably, the said completely sealed sulfur lamp contains a waveguide within the said case. The said magnetron is coupled to the said quartz bulb by the said waveguide.

Preferably, the said completely sealed sulfur lamp contains a coaxial cable within the said case. The said magnetron is coupled to the said quartz bulb by the said coaxial cable.

Preferably, the heat conducting media inside the said case of the said completely sealed sulfur lamp consists of at least one of the following heat conducting materials: metal, heat conducting oil, heat conducting resin and heat conducting rubber.

Preferably, the said sealed sulfur lamp contains an oil pump inside the said case to accelerate heat exchange.

Preferably, inside the said sealed sulfur lamp, a high temperature seal component is installed at that anode of the said magnetron to prevent leakage of the heat conducting medium from the anode.

Compared with existing technologies, this invention has the following advantages:

1. Existing sulfur lamp is driven by a high voltage generated by a LC transformer using line voltage. Force air cooling is employed to cool the magnetron and the high voltage transformer and generator. Such arrangement results in low efficiency and poor cooling, which also reduce the life of the magnetron. By using an electronic switching high voltage power supply, the temperature of the magnetron is greatly reduced. The lower magnetron temperature allows the use of heat conducting media for heat exchange and hence making a sealed sulfur lamp possible.
2. The said LC high voltage transformer is bulky and heavy. This invention would reduce the size and weight of the lamp, hence reducing the cost of the product. At lower working temperature, the life time of the lamp is extended. The completely sealed sulfur lamp is more reliable and easy to install, capable of working under adverse environment.

### DESCRIPTION OF FIGURES

FIG. 1. Schematic diagram of the circuit in a completely sealed sulfur lamp according to this invention.

FIG. 2. The cross section of a completely sealed sulfur lamp showing different components according to this invention.

### DESCRIPTION OF PREFERRED EMBODIMENTS

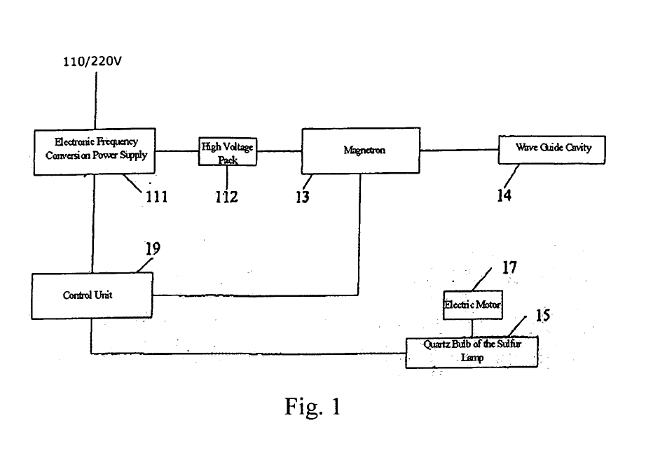

FIG. 1 is the schematic diagram of the sealed sulfur lamp used in this invention.

In FIG. 1, the electronic switching power supply 111 and high voltage generator 112 form the major components of the direct-current (DC) high voltage circuitry. Its purpose is to generate a high voltage direct-current. Kilovolts of direct-current is generated by the high voltage generator 112 powered by the high frequency current supplied by the electronic switching power supply 111 running at line voltage. The high voltage direct-current is connected to the magnetron 13 for generation of microwave. Such microwave is coupled to the quartz bulb 15 via a waveguide 14. During the starting stage, the inert gas inside the quartz bulb is excited by the microwave which in term heats the whole bulb 15. The heated sulfur vapor inside the bulb thus generates a continuous spectrum of light.

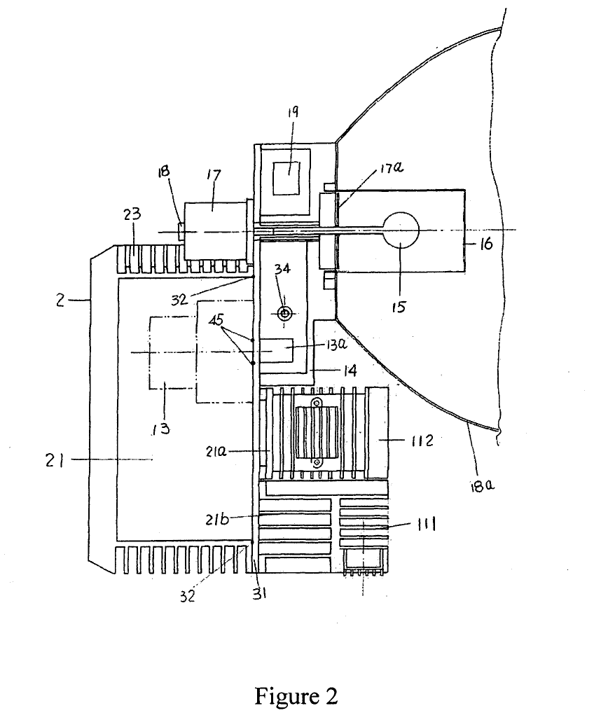

To reduce leaking of microwave, the bulb 15 is shield by a metallic shield 16 (FIG. 2). The bulb 15 is also rotated by the electric motor 17 in order to make the temperature and the illumination more uniform inside the bulb. A high temperature quartz mirror 17a is placed behind the bulb 15 to reflect the light to the front. A control circuit 19 couples with the electronic switching power supply 111, magnetron 13 and bulb 15 intelligently monitor the operation conditions and ensure a safe and reliable operation.

FIG. 2 is a cross section of the completely sealed sulfur lamp according to this invention.

As shown in FIG. 2, the magnetron 13, electronic switching power supply 111, high voltage direct-current generator 112 and waveguide 14 are placed inside the case 2. Inside case 2, there are heat transfer media 21, 21a and 21b (for example, heat conducting rubber, heat conducting oil and heat conducting resin). Outside the case 2, there are controlling circuitry 19, electric motor 17 and oil pump 18. The oil pump 18 is connected to case 2 via tubing. The purpose of the oil pump is to improve the circulation of the heat transfer media which improve that heat dissipation efficiency. Case 2 should be made of metallic material such as aluminum alloys. Metallic heat conducting fins 23 are added to the outside of case 2 as shown in FIG. 2. The metallic heat conducting fins may be made in groups.

Outside case 2, there are the quartz bulb 15 and a metallic shield 16. A cable goes through case 2 and connects to motor 17, controlling circuitry 19 and oil pump 18.

As shown in FIG. 2, case cover 31 covers case 2 and fixed with it. An o-ring 32 is placed between case 2 and case cover 31 in order to isolate the two sides. The fixture 34, bulb 15, metallic shield 16, reflector 18a, reflecting mirror 17a and waveguide 14 are fixed on the case cover 31.

As shown in FIG. 2, the magnetron 13 is mounted on the case cover 2. To eliminate the chance of leaking of heat conducting media such as heat conducting oil, a high temperature sealant 45 is slipped over the anode 13a of magnetron 13.

Since magnetron 13 is immersed in the heat conducting media which is inside case 2 with heat conducting fins 23, the heat generated by the magnetron is conducted to case 2 via media 21. It is further dissipated into the air via the heat conducting fins 23. Thus the temperature of the magnetron is kept within its normal working range. Furthermore, heat generated from the electronic switch power supply 111 and high voltage generator 112 are conducted to case 2 via heat conducting media 21a and 21b. The heat is further dissipated into the air via heat conducting fins 23.

By using a precise and accurate design, the magnetron 13, electronic switching power supply 111 and high voltage generator 112 are sealed in case 2. As a result, the direct-current high voltage power supply and the magnetron are completely sealed.

Microwave is generated by a magnetron driven by a high voltage direct-current which is produced by a high voltage direct-current generator powered by an electronic switching power supply. The electronic switching power supply used in this invention has special components and circuitry to protect interference from magnetic field and single chip driver. Dual driven insolated Gate Bipolar Transistor (IGBT) which only switches current at zero potential is also used. The combination of these efforts improves the efficiency of the high voltage direct-current generator to over 90%. Together with the special arrangements in the high voltage generator, the efficiency of the magnetron is being improved from 60-70% to over 80%.

In the said completely sealed sulfur lamp, the operation temperature of the magnetron and electronic switching power supply drops from 150 to about 80 degrees Celsius as a result of heat conduction by the heat transport media circulated by the oil pump. By confining the operation temperature to about 80 degrees Celsius, the life span and the reliability of the magnetron are greatly improved. No forced air cooling is needed in cooling the lamp.

This invention makes the production of a completely sealed sulfur lamp possible. The totally sealed sulfur lamp is lighter, smaller, cost less, more reliable and easier to maintain. It can work in all kinds of adverse environment.

In the said completely sealed sulfur lamp, the electronic switching power supply is made in a form of a module which is shielded with anti-magnetic materials. The shielding also allows the single chip driver working in an interference-free environment. The pure driving waveform produced by the single chip driver drives the zero voltage switching IGBT. In this way, the electronic switch power supply can operate at an efficiency of over 90%. The flowing heat conducting oil carries away the heat generated by the power supply and hence maintaining normal operation temperature.

Engineers in this field may easily apprehend changes made in this invention after reading this document. The characteristics of the changes may be similar to what are commonly known in this area. Such commonly known characteristics may be used to substitute or add to the description in this document.

1. A completely sealed sulfur lamp comprising:
a. A direct-current high voltage power generator and coupling circuit for the said direct-current high voltage power generator and the magnetron. Microwave is generated when the magnetron is driven by the direct-current high voltage.
b. The bulb which is coupled to the magnetron consists of a gas which may emit light when excited by microwave.
c. A characteristic includes the completely sealed case of the said direct-current high voltage generator and the magnetron. The said case contains heat conducting media.

2. The said completely sealed sulfur lamp according to claim 1, wherein contains a waveguide inside the case. The said magnetron is coupled to the bulb via this waveguide.

3. The said completely sealed sulfur lamp according to claim 1, wherein contains a coaxial cable inside the case. The said magnetron is coupled to the bulb via this coaxial cable.

4. The said completely sealed sulfur lamp according to claim 1, wherein the heat conducting media is at least one of the following: heat conducting oil, heat conducting resin and heat conducting rubber.

5. The said completely sealed sulfur lamp according to claim 1, wherein has heat conducting fins on the outside of the case.

6. The said completely sealed sulfur lamp according to claim 1, wherein has an oil circulating pump outside the case to accelerate the heat exchange of the heat conducting media.

7. The said completely sealed sulfur lamp according to claim 1, wherein a high temperature seal component is installed at the anode of the magnetron to prevent leakage of heat conducting media.
